(19) United States
(12) Patent Application Publication
(10) Pub. No.: US 2004/0153720 A1
(43) Pub. Date: Aug. 5, 2004

(54) Image recording/reproducing apparatus capable of reducing hard disc drive space waste

(76) Inventor: Chang-Rok Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/640,635

(22) Filed: Aug. 14, 2003

(30) Foreign Application Priority Data
Aug. 17, 2002 (KR) 2002-48729

(51) Int. Cl. H02H 3/05

(52) U.S. Cl. 714/5

(57) ABSTRACT

A hard disc drive (HDD) image recording/reproducing apparatus (HDD image recorder) capable of optimizing the space of a hard disc drive. The HDD image recorder comprises a cluster forming unit for forming a plurality of clusters of different sizes, a size information search unit for searching size information of a file from attribute information of the file to be stored, a cluster search unit for comparing the searched size information with a cluster from the least size out of the plurality of clusters and searching a cluster of suitable size in which the file is stored, and a file record unit for recording the file in the searched cluster of suitable size. If a file stored in a lower or inferior cluster is deleted, the size information search unit searches size information of a file stored in a higher or super cluster, and if the search file can be stored in a lower cluster, the file record unit moves it to the lower cluster and records the file stored in the super cluster. The HDD image recorder can automatically optimize the space of the hard disc drive in case of recording a file as well as deleting the file.

### CROSS REFERENCE TO RELATED APPLICATIONS

This application claims benefit under 35 U.S.C. § 119 from Korean Patent Application No. 2002-48729, filed on Aug. 17, 2002, the entire content of which is incorporated herein by reference.

### BACKGROUND OF THE INVENTION

1. Field of the Invention

The present invention relates to an image recording/reproducing apparatus, and more particularly, to an image recording/reproducing apparatus capable of optimizing the file storage space of a hard disc drive.

2. Description of the Prior Art

An image recording/reproducing apparatus capable of recording and reproducing broadcast signals to and from recording media expands its functions with the developments of technologies for digitizing and compressing broadcast signals. Image recording/reproducing apparatuses appearing in the market frequently employ a hard disc drive as a mass storage device. It is also the trend that such image recording/reproducing apparatuses have been developed to support the use of diverse video image source such as satellite broadcast signals, cable broadcasts, and network broadcasts through the Internet.

Such image recording/reproducing apparatuses appear in the market as a combination product that combines a first device and a second device, each of which performs an independent function, but have the common function of reproducing audio/visual (A/V) signals. The combination product combining the first device and the second device into one housing is referred to as an image recording/reproducing apparatus.

FIG. 1 is a block diagram schematically showing a DVD/HDD image recording/reproducing apparatus combining a DVD ROM and a hard disc drive (HDD) into one housing as one example of an image recording/reproducing apparatus.

As shown in FIG. 1, a DVD/HDD image recording/reproducing apparatus 10 has a form that combines in one housing a DVD ROM 12 for reproducing data recorded in recording media and a hard disc drive (HDD) 14 for recording and reproducing data to and from recording media. The DVD ROM 12 and the HDD 14 have interfaces for mutual data communications while carrying out independent functions respectively. In general, the DVD ROM 12 reproduces data recorded in optical disc recording media such as a digital video disk (DVD), audio CD, video CD, MP3 CD, and so on.

The DVD/HDD image recording/reproducing apparatus 10 can receive broadcast signals from external sources, and record then in the HDD 14, and subsequently externally output the broadcast signals. Further, the DVD/HDD image recording/reproducing apparatus 10 can output to external devices externally received broadcast signals, data reproduced from the DVD ROM 12, and data reproduced from the HDD 14. The DVD/HDD image recording/reproducing apparatus 10 can output broadcast signals and data to an audio amplifier 15, a TV set 17, and a camcorder 19 (among other devices), based on its output characteristics. Further, the DVD/HDD image recording/reproducing apparatus 10 can record in the HDD 14 data output from the audio amplifier 15, TV set 17, and camcorder 19 (among other devices).

The DVD/HDD image recording/reproducing apparatus 10 also comprises an additional feature in which the HDD 14 can record data reproduced from the DVD ROM 12, as well as externally received data.

In general, the hard disc drive 14 is configured to have clusters used in a personal computer (PC). FIG. 2 is a view showing the allocation of clusters used in the PC. As one skilled in the art can appreciate, the cluster is an aspect of storage technology for the PC. The cluster is a logical unit for storing files on a hard disc, which is managed by the operating system of a computer. At least one or more clusters are taken up if a file is stored on a hard disc, and several clusters may be taken up for a very big file. Even though one file is divided into several clusters, the clusters are not necessarily continuous in their locations all the time, and therefore can be randomly located on the hard drive. The discontinuous locations of several clusters associated with one file are managed by a file allocation table (FAT) for a hard disc, so there is no need for a user to know which files are stored in which clusters, or whether a file is stored in discontinuous clusters, or the like.

Since a cluster is not a physical unit, but a logical unit formed in a hard disc itself, a cluster can be formed in diverse sizes depending upon circumstances. However, even a file of small data amount takes up at least one cluster, which causes the problem of wasting clusters. For example, a cluster that is allocated 2048 bytes, will waste the greater majority of its storage space if the file allocated to that cluster is only 10 bytes. This is an inefficient use of hard disk space.

### SUMMARY OF THE INVENTION

An object of the present invention is to substantially solve at least the above problems and/or disadvantages and to provide at least the advantages described below.

Accordingly, it is an object of the present invention to provide a method for optimizing storage space on a video recording/reproducing hard disk drive, the method comprising the steps of forming a plurality of clusters on the hard disk drive (HDD) of one or more storage sizes, searching size information of a file to be stored in the HDD, and searching storage size information of the plurality of formed clusters on the HDD, if the file to be stored is a new file is to be stored, and storing the new file in a cluster that optimizes HDD storage space.

It is a further object of the present invention to provide video recording/reproducing apparatus adapted to optimize storage space on a hard disk drive (HDD), the apparatus comprising a cluster forming unit for forming plural clusters of different sizes, a size information search unit for searching size information of a file from attribute information of the file to be stored, a cluster search unit for comparing the searched size information with a cluster from the least size out of the plural clusters and searching a cluster of suitable size in which the file is stored, and a file record unit for recording the file in the searched cluster of suitable size.

### BRIEF DESCRIPTION OF THE DRAWINGS

The above object and other features of the present invention will become apparent by describing in detail certain embodiments thereof with reference to the attached drawings, in which:

FIG. 1 is a block diagram schematically showing a DVD/HDD image recording/reproducing apparatus combining a DVD ROM and a hard disc drive (HDD) in one housing;

FIG. 2 is a view for showing cluster allocations used in a general personal computer (PC);

FIG. 3 is a block diagram for explaining a DVD/HDD image recording/reproducing apparatus;

FIG. 4 is a block diagram schematically showing a HDD image recording/reproducing apparatus according to an embodiment of the present invention;

FIG. 5 is a view showing cluster allocations formed according to an embodiment of the present invention; and

FIG. 6 is a flow chart showing an example of an image recording method used in accordance with the HDD image recording/reproducing apparatus of FIG. 4.

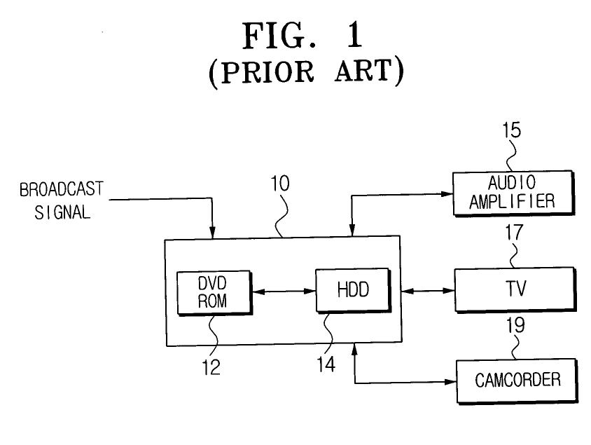

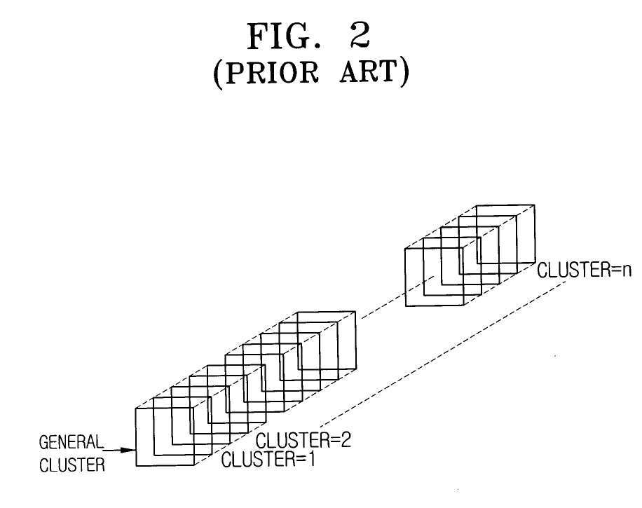

### DETAILED DESCRIPTION OF THE PREFERRED EMBODIMENT

Hereinafter, certain embodiments of the present invention are described in more detail with reference to the accompanying drawings.

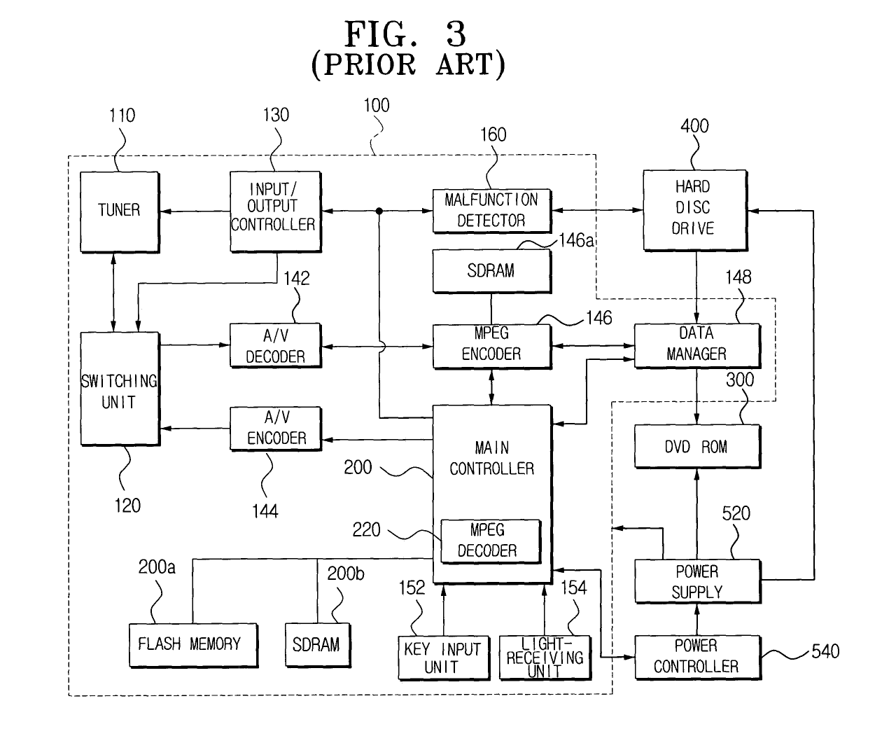

FIG. 3 is a block diagram for explaining a DVD/HDD image recording/reproducing apparatus.

Referring to FIG. 3, the DVD/HDD image recording/reproducing apparatus is provided with a signal processor 100, a DVD ROM 300, a hard disc drive (HDD) 400, a power supply 520, and a power controller 540.

The signal processor I 00 controls the operations of the DVD ROM 300 and the hard disc drive 400 for recording and reproducing data, and encodes and decodes data externally transmitted, based on the controls of the main controller 200.

The DVD ROM 300 reproduces data respectively recorded on optical disc record media such as DVDs, audio CDs, video CDs, MP3 CDs, and so on. Further, the DVD ROM 300 may record externally inputted data on optical disc record media.

The hard disc drive 400 records externally input data and reproduces recorded data.

The power supply 520 converts input electric power into voltages of set levels and supplies the voltages necessary for the operations of the DVD ROM 300, hard disc drive 400, and signal processor 100.

If the power controller 540 receives a reset command from the main controller 200 to restart the DVD/HDD image recording/reproducing apparatus, the power controller 540 controls the power supply 520 to cut off and then re-supply the power supply operation of the power supply 520.

The signal processor 100 is provided with a tuner 110, a switching unit 120, an A/V decoder 142, an A/V encoder 144, an MPEG encoder 146, a data manager 148, and the main controller 200.

The tuner 110 tunes receiving channels to a broadcast signal requested by an input/output controller 130, controlled by the main controller 200.

The switching unit 120 is controlled by the input/output controller 130 to selectively connect input/output terminals (not shown) with one another which are connected to external A/V input/output devices.

The ANV decoder 142 is controlled by the main controller 200 to decode an audio/video signal received through the switching unit 120 and output the decoded signal to the MPEG decoder.

The AN encoder 144 encodes and outputs to the switching unit 120 data MPEG-decoded in the MPEG decoder 220 of the main controller 200 and audio/video signals decoded in the A/V decoder 142.

The MPEG encoder 146 is controlled by the main controller 200 to encode in a known compression format, audio and video signals output from the A/V decoder 142, and stores to-be-recorded data in the hard disc drive 400 of mass storage device. Preferably, the MPEG encoder 146 carries out the encoding in the MPEG-2 compression format. Reference numeral 146a indicates an SDRAM employed as memory used for an encoding process in the MPEG encoder 146.

The data manager 148 manages reproducing and recording data recorded in the hard disc drive 400 and/or the DVD ROM 300. The data manager 148 is controlled by the main controller 200 to manage the storage of data recorded in the DVD ROM 300 into the hard disc drive 400, the storage of data recorded in the hard disc drive 400 into the DVD ROM 300, and the storage of data encoded in the MPEG encoder 146 into the hard disc drive 400.

A key input unit 152 is employed as an interface and provided with manipulation keys for a user to select corresponding commands, and transmits to the main controller 200 a user manipulation signal selected by the user. Further, a light-receiving unit 154 is employed as an interface to receive a user manipulation signal emitted from an external input device such as a remote controller and transmit it to the main controller 200.

The main controller 200 processes a user manipulation signal received through the key input unit 152 and the light-receiving unit 154 and controls the respective constituents. An exemplary main controller 200 is formed in a single chip in which the MPEG decoder 220 (which decodes signal compressed in the MPEG format) and a central processing unit are combined.

In flash memory 200a an operation program of the main controller 200 is recorded. In the flash memory 200a a menu guide/process unit is installed which performs a process for showing a menu guide list on a screen of a display device. Reference numeral 200b indicates the SDRAM that the main controller 200 uses as a temporary storage space.

In the DVD/HDD image recording/reproducing apparatus illustrated in FIG. 3, the main controller 200 loads a program installed in the flash memory 200a when getting started and processes operations for various functions corresponding to commands received through the key input unit 152 and the light-receiving unit 154.

The DVD ROM 300 reproduces motion picture data recorded in optical disc record media. The hard disc drive 400 records and reproduces motion picture data output from and recorded in the MPEG encoder 146 and the DVD ROM 300 according to the control of the data manager 148. Accordingly, the storage space of the hard disc drive 400 has a data record area and a user record area. The data record area is where motion picture data is recorded, and includes therein a data attribute information area. The data attribute information area is one for recording attribute information such as data record dates, file sizes, and so on. The main controller 200 searches and records in the data attribute information area data attribute information included in data itself when data is recorded in the hard disc drive 400.

The user record area is the location used for recording additional information edited by a user as to motion picture data. Information recorded in the user record area may be data names, directories, and so on.

HDD 400 preferably records the additional information together with backup data corresponding to the additional information when recording the additional information in the user record area. Further, the HDD 400 may additionally record error check information for checking errors with respect to the additional data and backup data recorded when recording the additional information and backup data in the user record area.

Further, the DVD/HDD image recording/reproducing apparatus has a malfunction detector 160 which decides whether the apparatus is experiencing a malfunction. The malfunction detector 160 decides whether errors occur as to the recording operations of the HDD 400 and transmits the result of this decision to the main controller 200, while motion picture data is recorded in the data record area by the hard disc drive 400.

If it is decided that the HDD 400 is experiencing a malfunction, the main controller 200 controls the power supply 520, which supplies electric power to the DVD/HDD image recording/reproducing apparatus, to control the power controller 540 to restart the DVD/HDD image recording/reproducing apparatus including the DVD ROM 300 and the hard disc drive 400. Accordingly, the power controller 540 causes the power supply 520 momentarily interrupt electric power according to a system reset command transmitted from the main controller 200.

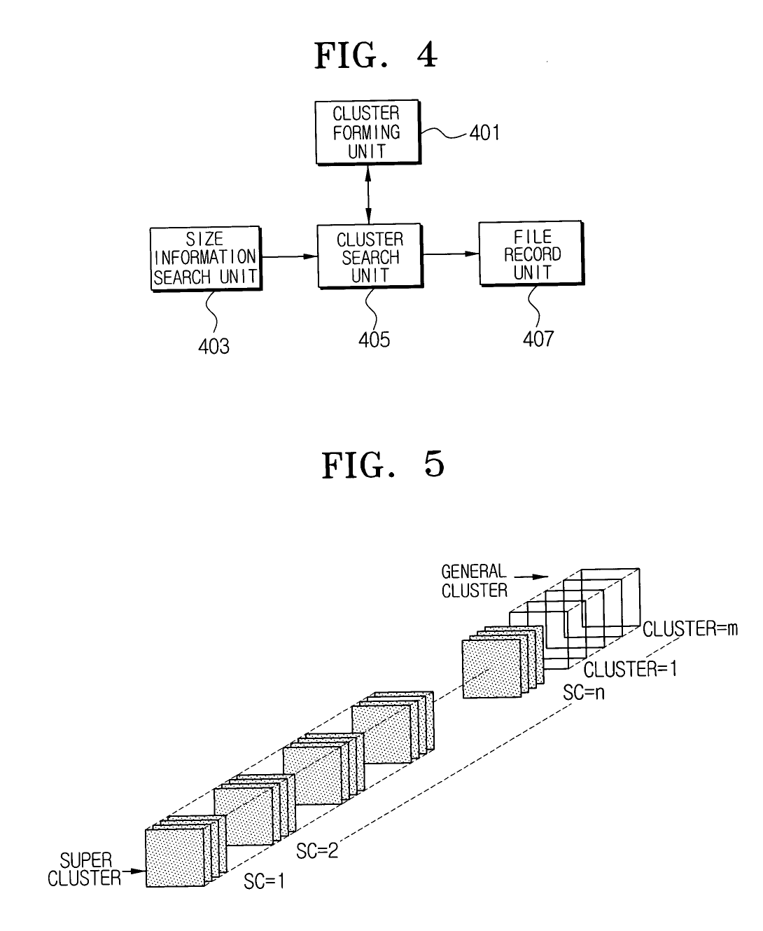

FIG. 4 is a block diagram schematically showing a HDD image recording/reproducing apparatus according to the present invention. Referring to FIG. 4, the HDD image recording/reproducing apparatus is provided with a cluster forming unit 401, a size information search unit 403, a cluster search unit 405, and file record unit 407.

The cluster forming unit 401 forms a plurality of clusters of different sizes when formatting the hard disc drive 400. The cluster allocation formed in FIG. 4 is shown in FIG. 5. As shown in FIG. 5, clusters can be formed in various steps by size, and a plurality of plural clusters may be formed for the size of each step.

The size information search unit 403 searches file-size information from the attribute information of a file to be recorded.

If the size information of a file to be recorded is searched, the cluster search unit 405 compares the size information of a searched file with the plurality of clusters formed by the cluster forming unit 401, and searches for a cluster suitable for the storage of the file. Suitability, in this instance, means the size of the file is less than or equal to the size of the cluster, but greater in size than the next smallest cluster.

The file record unit 407 records the file in a cluster of suitable size which is searched by the cluster search unit 405.

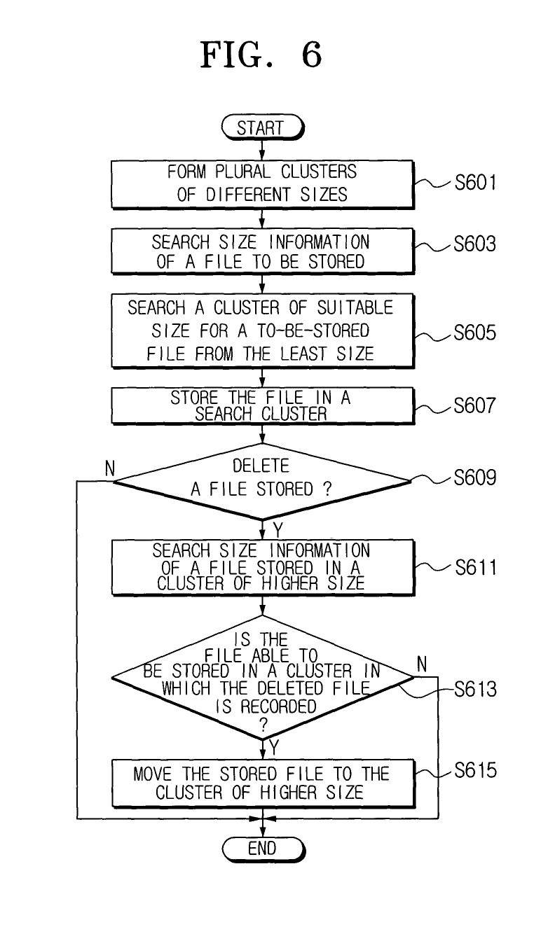

FIG. 6 is a flow chart showing an example of an image record method using the HDD image recording/reproducing apparatus of FIG. 4. As shown in FIG. 6, the HDD image recording/reproducing apparatus and method according to the present invention are described in more detail.

If the HDD 400 is formatted, the cluster forming unit 401 forms a plurality of clusters of different sizes (step S601). For example, the clusters may be formed in the order of size, e.g., in the order of 512 bytes, 1024 bytes, 2048 bytes, and so on, with three clusters of 512 bytes, five clusters of 1024 bytes, and one cluster of 2048 bytes. This is, as one skilled in the art can appreciate, but one example. Many different combinations of cluster sizes exist.

In step S603, the size information search unit 403 searches file size information from attribute information included in the file to be recorded.

If the file size information is searched, the cluster search unit 405 compares the searched size information with the size of every formed cluster to determine the most suitable cluster in which the file should be recorded (step S605). In this case, the cluster search unit 405 sequentially searches the searched size information and the clusters from the least size out of the plurality of clusters formed by the cluster forming unit 401. For example, if a file searched by the size information search unit 403 has a size of 420 bytes and the formed clusters have the sizes of 512 bytes, 1024 bytes, and 2048 bytes, the cluster search unit 405 searches and selects the cluster of 512 bytes, since storing the file in the cluster of 512 bytes minimizes the waste of space on the HDD 400. If a searched file has a size of 420 bytes and another file has already been stored in a formed cluster of 512 bytes, the cluster search unit 405 sequentially searches out a cluster of next larger size, i.e., the cluster of 1024 bytes (assuming there is only one formed cluster of 512 bytes).

The file record unit 407 records the file in the cluster found by the cluster search unit 405, thereby optimizing usage of space on the HDD 400 (step S607).

If a file stored in the hard disc drive 400 is deleted (“Yes” path from decision step S609), the size information search unit 403 searches the size information of a file recorded in a cluster of a higher size, or “super” clusters, than the cluster in which the deleted file is recorded (step S611).

If the file recorded in a higher cluster found by the size information search unit 403 can be recorded in the cluster in which the deleted file was recorded (“Yes” path from decision step S613), the file record unit 407 moves and records the file recorded in the higher cluster to the lower cluster i.e., the cluster in which the deleted file was recorded (step S615). For example, if a file of 420 bytes is recorded in a cluster of 512 bytes and a file of 370 bytes is recorded in a cluster of 1024 bytes, and the file recorded in the cluster of 512 bytes is deleted, the size information search unit 403 searches and determines the size information of the file recorded in the cluster of 1024 bytes. In this case, since the file recorded in the cluster of 1024 bytes can be recorded in the cluster of 512 bytes, the file record unit 407 moves and records the file recorded in the cluster of 1024 bytes to the cluster of 512 bytes. In this manner, the DVD/HDD image recording/reproducing apparatus optimizes usage of the newly formed space of a hard disc drive 400 in the event that files recorded in the HDD 400 are deleted.

The HDD image recording/reproducing apparatus according to embodiments of the present invention can automatically optimize the space of the HDD 400 without manual manipulations when recording and deleting files in the HDD 400 While the invention has been shown and described with reference to a certain embodiments thereof, it will be understood by those skilled in the art that various changes in form and details may be made therein without departing from the spirit and scope of the invention as defined by the appended claims.

What is claimed is:

1. A method for optimizing storage space on a video recording/reproducing hard disk drive, comprising:
forming a plurality of clusters on the hard disk drive (HDD) of one or more storage sizes;
searching size information of a file to be stored in the HDD; and
searching storage size information of the plurality of formed clusters on the HDD, if the file to be stored is a new file is to be stored, and storing the new file in a cluster that optimizes HDD storage space.

2. The method according to claim 1, further comprising:
deleting a file stored in a cluster; and
searching size information of a file stored in a cluster of a next higher storage size than the deleted file and moving the file stored in the cluster of the next higher storage size to the cluster of the deleted file if the storage size of the cluster of the deleted file is greater than the file stored in the cluster of the next higher storage size.

3. The method according to claim 2, wherein the step of forming a plurality of clusters on the hard disk drive (HDD) of one or more storage sizes is performed by a cluster forming unit.

4. The method according to claim 2, wherein the step of searching size information of a file to be stored in the HDD is performed by a size information search unit.

5. The method according to claim 2, wherein the step of searching size information of a file to be stored in the HDD comprises:
searching size information of a file from attribute information of the file to be stored.

6. The method according to claim 2, wherein the step of searching storage size information of the plurality of formed clusters comprises:
comparing the searched size information with a cluster from the least size out of the plural clusters and searching a cluster of suitable size in which the file is stored; and
recording the file in the searched cluster of suitable size.

7. A video recording/reproducing apparatus adapted to optimize storage space on a hard disk drive (HDD), comprising:
a cluster forming unit for forming plural clusters of different sizes;
a size information search unit for searching size information of a file from attribute information of the file to be stored;
a cluster search unit for comparing the searched size information with a cluster from the least size out of the plural clusters and searching a cluster of suitable size in which the file is to be stored to optimize HDD storage space; and
a file record unit for recording the file in the searched cluster of suitable size.

8. The apparatus according to claim 7, further comprising:
a hard disk drive, wherein the storage space of the hard disk drive is configured to be formed into a plurality clusters by the cluster forming unit.

9. The apparatus according to claim 8, further comprising:
a data manager for managing the storage of data on the hard disk drive; and
a main control unit for controlling the data manager.
